(19) United States
(12) Patent Application Publication
(10) Pub. No.: US 2009/0213055 A1
(43) Pub. Date: Aug. 27, 2009

(54) DISPLAY DEVICE CAPABLE OF BRIGHTNESS ADJUSTMENT BY ADJUSTING GAMMA CURVE AND METHOD THEREOF

(75) Inventors: Mao-Jung Chung, Tainan County (TW); Yu-Shen Kung, Tainan County (TW); Chin-Cheng Liu, Tainan County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 12/036,759

(22) Filed: Feb. 25, 2008

(51) Int. Cl. G09G 3/36

(52) U.S. Cl. 345/89

(57) ABSTRACT

Provided is a display device capable of brightness adjustment by adjusting gamma curves thereof, without adjusting brightness of input video signals. The display device includes a memory unit, storing a plurality of gamma reference voltage value sets in accordance with a plurality of gamma curves; a microprocessor, for selecting one of the gamma reference voltage value sets stored in the memory unit; a gamma voltage generator, for generating a plurality of gamma reference voltages in response to the selected gamma reference voltage value set from the microprocessor; a data converter, for converting input video signals into video voltages in response to the gamma reference voltages provided from the gamma voltage generator; and a display panel, for displaying images in response to the video voltages from the data converter.

### BACKGROUND OF THE INVENTION

1. Field of Invention

The present invention relates to a display device and method thereof, capable of brightness adjustment by adjusting gamma curves, rather than adjusting brightness of input video signal.

2. Description of Related Art

In the information society at the present time, electronic display apparatuses are more important as information transmission media and various electronic display apparatuses are widely applied for industrial apparatus or home appliances. Such electronic display apparatuses continue to advance to have new appropriate functions for various demands of the information society.

In general, electronic display apparatuses display and transmit various pieces of information to users who utilize such information. That is, the electronic display apparatuses convert electronic information signals outputted from an electronic apparatus into light information signals recognized by users' vision.

In current display devices or display systems, such as CRT or LCD, the input voltage and emission output are not in a linear relationship. Gamma compensation is performed for digital data or analog data.

In the state of art, in order to adjust image brightness, brightness values corresponding to input video signals are adjusted. FIG. 1 shows a simplified diagram for showing brightness adjustment according to the state of art. As shown in FIG. 1, a video data processor 110 adjusts brightness values (i.e. gray scale values) of input video signals RGB to produce a brightness-adjusted video signals R′G′B′ for inputting to a driving circuit 120. The driving circuit 120 converts the brightness-adjusted video signals R′G′B′ into video voltages (i.e. gray scale voltages). A display panel 130 display images based on the video voltage from the driving circuit 120.

However, accompanied with brightness adjustment, while increasing the brightness of the image, the video data processor amplify all of the brightness values of input video signals RGB, and the brightness-adjusted video signals R′G′B′ will have more higher brightness values than the originally input video signals RGB. In addition, the brightness values of the brightness-adjusted video signals R′G′B′ provided for dark state region of the image will also be raised in contrast to the original ones. In other words, the contrast ratio of the brightness-adjusted video signals R′G′B′ are degraded and so is the display quality thereof.

Therefore, it is preferred to have a display device and method thereof, which are capable of brightness adjustment by adjusting gamma curves, rather than adjusting brightness of input video signal. So, the contrast ratio and display quality are maintained while images are displayed at higher brightness.

### SUMMARY OF THE INVENTION

The invention provides a display device which is capable of brightness adjustment by adjusting gamma curves, rather than adjusting brightness of input video signal. So, the contrast ratio and display quality are maintained while images are displayed at high brightness.

The invention provides a display method which is capable of balancing between brightness compensation, contrast ratio and display quality, by adjusting applied gamma curves, rather than adjusting brightness of input video signal.

Therefore, it is preferred to have a display device and method thereof, which are capable of brightness compensation while without negatively affecting gray scale distribution of input video signal.

One example of the invention provides a display device capable of brightness adjustment by adjusting a gamma curve thereof. The display device comprises: a memory unit, storing a plurality of gamma reference voltage value sets in accordance with a plurality of gamma curves; a microprocessor, coupled to the memory unit, for selecting one of the gamma reference voltage value sets stored in the memory unit; a gamma voltage generator, coupled to the microprocessor, for generating a plurality of gamma reference voltages in response to the selected gamma reference voltage value set from the microprocessor; a driving circuit, coupled to the gamma voltage generator, for converting input video signals into video voltages in response to the gamma reference voltages provided from the gamma voltage generator; and a display panel, coupled to the driving circuit, for displaying in response to the video voltages from the driving circuit.

In the above example, the display device further includes: a user interface, operably in response to a user input, wherein the selection by the microprocessor being in accordance with an output from the user interface. The user interface includes a keypad or a remote controller.

In the above example, the memory unit includes an EEPROM and the driving circuit includes a source driver.

Further, another example of the invention provides a method for adjusting display brightness in a display device, the method comprising: (a) providing a plurality of predetermined gamma reference voltage value sets in accordance with a plurality of predetermined gamma curves; (b) selecting one from the predetermined gamma reference voltage value sets in response to a user input; (c) generating a plurality of gamma reference voltages in response to the selected gamma reference voltage value sets; (d) converting input video signals into video voltages in response to the gamma reference voltages generated in the step (c); and (e) displaying images in response to the video voltages converted in the step (d).

Still another example of the invention provides a display device capable of brightness adjustment by adjusting a gamma curve thereof. The display device comprises: a memory unit, storing a plurality of gamma reference voltage value sets in accordance with a plurality of gamma curves; a microprocessor, coupled to the memory unit, for selecting one of the gamma reference voltage value sets stored in the memory unit; a driving circuit, coupled to the microprocessor, for generating a plurality of gamma reference voltages in response to the selected gamma reference voltage value set from the microprocessor, and the driving circuit further for converting input video signals into video voltages in response to the gamma reference voltages provided from the gamma voltage generator; and a display panel, coupled to the driving circuit, for displaying in response to the video voltages from the driving circuit.

In the above example, the driving circuit includes: a gamma voltage generator, coupled to the microprocessor, for generating the gamma reference voltages in response to the selected gamma reference voltage value set from the microprocessor; and a data converter, coupled to the gamma voltage generator, for converting the input video signals into the video voltages in response to the gamma reference voltages provided from the gamma voltage generator.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a simplified diagram for showing brightness adjustment according to the state of art.

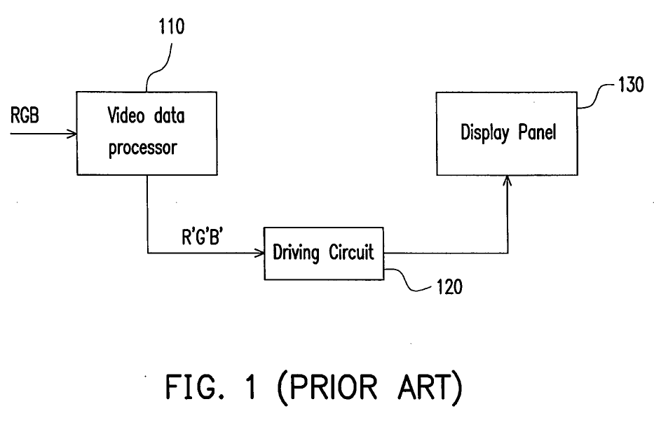

FIG. 2 shows a display device 200 according to an embodiment of the invention.

FIG. 3 shows several applicable gamma curves for brightness adjustment.

FIG. 4 shows another display device 400 according to another embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

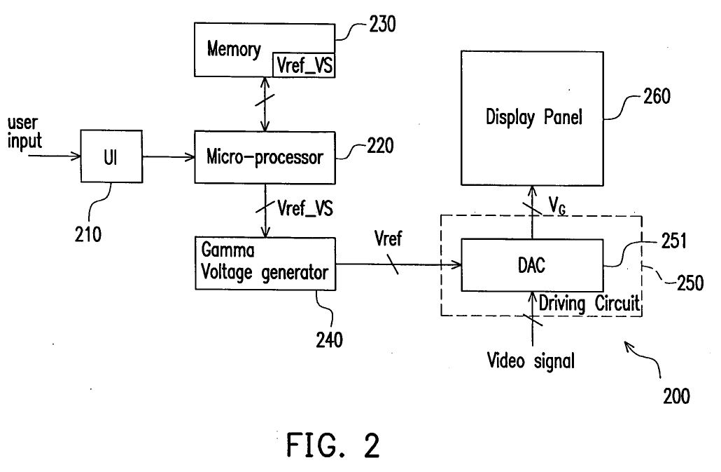

FIG. 2 shows a display device 200 according to an embodiment of the invention, which is capable of brightness adjustment by adjusting a gamma curve thereof, without adjusting brightness of input video signals. So, the image contrast and resolution of the input video signals are not degraded.

The display device 200 comprises a user interface 210, a microprocessor 220, a memory unit 230, a gamma voltage generator 240, a driving circuit 250 and a display panel 260. The driving circuit 250 further comprises a data converter 251, for example, a digital-to-analog converter (DAC).

The user interface 210 is operably in response to user input. The user interface 210 is for example but not limited by a keypad or a remote controller. In other words, in the embodiment, the user may adjust image display brightness just by a keypad or a remote controller. For example, the display device is applicable in a TV-set placed in a living room. When user feels the image is display with lower brightness, user may just adjust display brightness by operating the remote controller easily, quickly and interactively.

The memory unit 230 is coupled to the microprocessor 220. The memory unit 230 stores a plurality of gamma reference voltage value sets Vref_VS in accordance with a plurality of gamma curves. The memory unit 230 is for example but not limited by an EEPROM. Further, the memory unit 230 is programmable, which means, the gamma reference voltage value sets stored in the memory unit 230 are also programmable.

The microprocessor 220 is coupled to the memory unit 230 and the user interface 210. The microprocessor 220 selects one of the gamma reference voltage value sets Vref_VS stored in the memory unit 230 in accordance with the output of the user interface 210. In other words, the selection by the microprocessor is accordance with user command.

The gamma voltage generator 240 is coupled to the microprocessor 220. The gamma voltage generator 240 is for generating a plurality of gamma reference voltages Vref in response to the selected gamma reference voltage value set Vref_VS from the microprocessor 220.

The driving circuit 250 is coupled to the gamma voltage generator 240. The driving circuit 250 is for converting input video signals into video voltages V_{G} in response to the gamma reference voltages Vref provided from the gamma voltage generator 240. The driving circuit 250 is for example, a source driver. People skilled in the art should know that the driving circuit 250 includes other necessary component, although not shown in FIG. 2.

The display panel 260 is coupled to the driving circuit 250. The display panel 260 is for displaying images in response to the video voltages V_{G} from the driving circuit 250. The display panel 260 is for example, a Liquid Crystal On Silicon panel (LCOS panel).

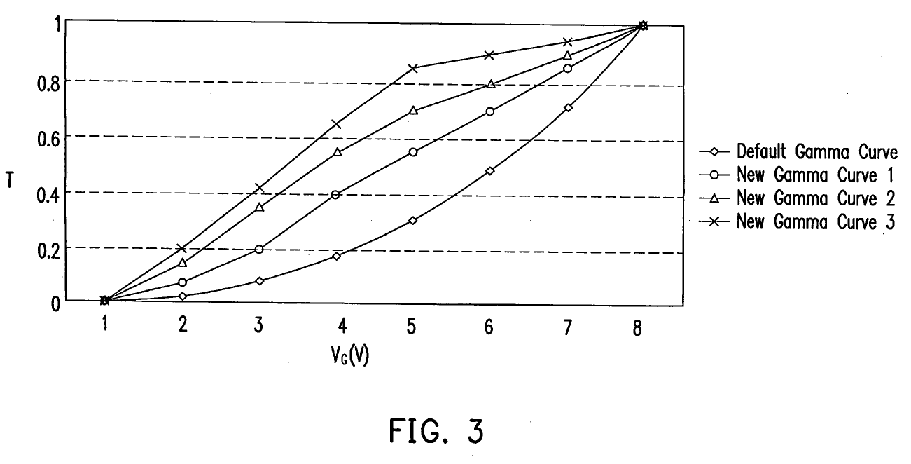

FIG. 3 shows several gamma curves for brightness adjustment. T refers to transmittance percentage of pixels in the display panel. As shown in FIG. 3, the default gamma curve has lower transmittance percentage, i.e. lower brightness. But, new gamma curves have higher transmittance percentage, i.e. higher brightness. In general, most pixels of images have high or medium gray scale values. By new gamma curves, pixels are driven by higher video voltages (driving voltages). In other words, images shown in the display panel, in accordance to drive by higher video voltage, are displayed in high brightness. On the other hand, if user feels that brightness of displayed images is too high, user may adjust image brightness lower by applying gamma curves with low driving voltages. For example, based on user command, application of gamma curves may be changed from gamma curve 3 to gamma curve 2.

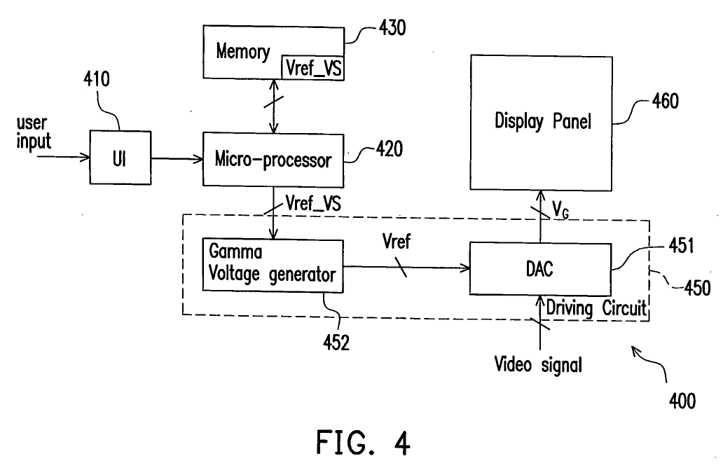

FIG. 4 shows another display device 400 according to another embodiment of the invention, which is capable of brightness adjustment by adjusting a gamma curve thereof, without adjusting brightness of input video signals. So, the image contrast and resolution of the input video signals are not degraded.

As shown in FIG. 4, the display device 400 comprises a user interface 410, a microprocessor 420, a memory unit 430, a driving circuit 450 and a display panel 460. The driving circuit 450 further comprises a gamma voltage generator 452 and a data converter 251, for example, a digital-to-analog converter (DAC).

The user interface 410, the microprocessor 420, the memory unit 430 and the display panel 460 have similar or the same function with those in FIG. 2, therefore, their detailed description are omitted. In FIG. 4, the gamma voltage generator 452 is disposed inside the driving circuit 450. The driving circuit 450 is for example, a source driver. In contrast to the driving circuit 250 shown in FIG. 2, the gamma voltage generator 452 is adapted to integrate in the source driver.

In summary, in the embodiments according to the invention, adjustment of display brightness in a display device includes: (a) providing a plurality of predetermined gamma reference voltage value sets in accordance with a plurality of predetermined gamma curves, in a memory unit which is programmable; (b) selecting one from the predetermined gamma reference voltage value sets in response to a user input, by a microprocessor; (c) generating a plurality of gamma reference voltages in response to the selected gamma reference voltage value sets, by a gamma voltage generator; (d) converting input video signals into video voltages in response to the gamma reference voltages generated from the gamma voltage generator; and (e) displaying images on a display panel, in response to the converted video voltages.

The embodiments according to the invention may be applicable in image display devices, such as TVs, projectors, computer monitors, and etc.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A display device capable of brightness adjustment by adjusting a gamma curve thereof, said display device comprising:
a memory unit, storing a plurality of gamma reference voltage value sets in accordance with a plurality of gamma curves;
a microprocessor, coupled to the memory unit, for selecting one of the gamma reference voltage value sets stored in the memory unit;
a gamma voltage generator, coupled to the microprocessor, for generating a plurality of gamma reference voltages in response to the selected gamma reference voltage value set from the microprocessor;
a driving circuit, coupled to the gamma voltage generator, for converting input video signals into video voltages in response to the gamma reference voltages provided from the gamma voltage generator; and
a display panel, coupled to the driving circuit, for displaying in response to the video voltages from the driving circuit.

2. The display device according to claim 1, further comprising:
a user interface, operably in response to a user input, wherein the selection by the microprocessor being in accordance with an output from the user interface.

3. The display device according to claim 2, wherein the user interface includes a keypad or a remote controller.

4. The display device according to claim 1, wherein the memory unit includes an EEPROM.

5. The display device according to claim 1, wherein the driving circuit includes a source driver.

6. A method for adjusting display brightness in a display device, the method comprising:
(a) providing a plurality of predetermined gamma reference voltage value sets in accordance with a plurality of predetermined gamma curves;
(b) selecting one from the predetermined gamma reference voltage value sets in response to a user input;
(c) generating a plurality of gamma reference voltages in response to the selected gamma reference voltage value sets;
(d) converting input video signals into video voltages in response to the gamma reference voltages generated in the step (c); and
(e) displaying images in response to the video voltages converted in the step (d).

7. The method according to claim 6, wherein the step (a) includes:
storing the predetermined gamma reference voltage value sets in a memory unit inside the display device.

8. The method according to claim 7, wherein the memory unit (230) includes an EEPROM.

9. The method according to claim 6, wherein the step (b) includes:
operating via a user interface of the display device for selecting, in response to the user input.

10. The method according to claim 9, wherein the user interface includes a keypad or a remote controller.

11. A display device capable of brightness adjustment by adjusting a gamma curve thereof, said display device comprising:
a memory unit, storing a plurality of gamma reference voltage value sets in accordance with a plurality of gamma curves;
a microprocessor, coupled to the memory unit, for selecting one of the gamma reference voltage value sets stored in the memory unit;
a driving circuit, coupled to the microprocessor, for generating a plurality of gamma reference voltages in response to the selected gamma reference voltage value set from the microprocessor, and the driving circuit further for converting input video signals into video voltages in response to the gamma reference voltages provided from the gamma voltage generator; and
a display panel, coupled to the driving circuit, for displaying in response to the video voltages from the driving circuit.

12. The display device according to claim 11, further comprising:
a user interface, operably in response to a user input, wherein the selection by the microprocessor being in accordance with an output from the user interface.

13. The display device according to claim 12, wherein the user interface includes a keypad or a remote controller.

14. The display device according to claim 11, wherein the memory unit includes an EEPROM.

15. The display device according to claim 11, wherein the driving circuit is a source driver.

16. The display device according to claim 11, wherein the driving circuit includes:
a gamma voltage generator, coupled to the microprocessor, for generating the gamma reference voltages in response to the selected gamma reference voltage value set from the microprocessor.

17. The display device according to claim 16, wherein the driving circuit further includes:
a data converter, coupled to the gamma voltage generator, for converting the input video signals into the video voltages in response to the gamma reference voltages provided from the gamma voltage generator.
